(19) United States
(12) Patent Application Publication
(10) Pub. No.: US 2025/0292920 A1
(43) Pub. Date: Sep. 18, 2025

(54) METHOD AND APPARATUS FOR CONTROLLING CORROSION IN A MOLTEN SALT REACTOR

(71) Applicants: Rolland Paul Johnson, Newport New, VA (US); Melissa Ann Rose, Dekalb, IL (US); Vadim G. Dudnikov, Alexandria, VA (US)

(72) Inventors: Rolland Paul Johnson, Newport New, VA (US); Melissa Ann Rose, Dekalb, IL (US); Vadim G. Dudnikov, Alexandria, VA (US)

(21) Appl. No.: 19/080,561

(22) Filed: Mar. 14, 2025

Related U.S. Application Data
(60) Provisional application No. 63/566,059, filed on Mar. 15, 2024.

(51) Int. Cl. G21C 19/31; G21C 1/30

(52) U.S. Cl. CPC G21C 19/31; G21C 1/303

(57) ABSTRACT

A system for nuclear power generation can include an accelerator-driven subcritical nuclear reactor that operates using molten-salt fuel. The reactor includes a target positioned to receive a proton beam and to be cooled by the molten-salt fuel. A voltage signal is applied to an electrode in contact with the molten-salt fuel in the reactor for controlling corrosion of the target and other portions of the reactor. In one embodiment, the target is used as the electrode. In another embodiment, an electrode other than the target is used.

### CLAIM OF PRIORITY

The present application claims the benefit of priority under 35 U.S.C. § 119 (e) of U.S. Provisional Patent Application No. 63/566,059, entitled “METHOD AND APPARATUS FOR CONTROLLING CORROSION IN A MOLTEN SALT REACTOR”, filed on Mar. 15, 2024, which is herein incorporated by reference in its entirety.

### TECHNICAL FIELD

The present disclosure relates generally to nuclear power generation and more particularly, but not by way of limitation, method and apparatus for controlling corrosion of molten salt reactor (MSR) components that contact the molten salt and corrosion of internal targets using one or more electrodes.

### BACKGROUND

Accelerator-driven subcritical reactors (ADSRs) have been developed by taking advantage of large advances in superconducting radio-frequency (SRF) accelerators. In the last decade, SRF proton accelerators have been demonstrated to have the power and efficiency to produce copious spallation neutrons needed to enable a molten salt (MS) fueled subcritical nuclear reactor. A significant challenge in operating an MS reactor is corrosion of reactor components that may occur due to the highly corrosive nature of molten salts. High temperatures and chemical reactivity of the MS fuel during operation of the MS reactor can cause material degradation of various reactor components. The corrosion occurs through dissolution of metal ions from the reactor components to the MS fuel and exposes the reactor to risks including leaks and compromised structural integrity.

### SUMMARY

A system for nuclear power generation can include an accelerator-driven subcritical nuclear reactor that operates using molten-salt (MS) fuel. The reactor includes a target positioned to receive a proton beam and to be cooled by the MS fuel. A voltage signal is applied to an electrode in contact with the MS fuel in the reactor for controlling corrosion of the target and other portions of the reactor. In one embodiment, the target is used as the electrode. In another embodiment, an electrode other than the target is used.

An example (“Example 1”) of a system for nuclear power generation is provided. The system includes an accelerator-driven subcritical nuclear reactor, an electrode, and a voltage source. The accelerator-driven subcritical nuclear reactor is configured to operate using MS fuel. The reactor includes a target positioned to receive a proton beam and to be cooled by the MS fuel. The electrode is positioned to be in contact with the MS fuel in the reactor. The voltage source is electrically coupled to the electrode and is configured to generate a voltage signal and to transmit the voltage signal to the electrode. The voltage signal is suitable for controlling corrosion of the target and one or more other portions of the reactor that are in contact with the MS fuel.

In Example 2, the subject matter of Example 1 may optionally be configured such that the target is made of uranium.

In Example 3, the subject matter of any one or any combination of Examples 1 and 2 may optionally be configured such that the target is used as the electrode.

In Example 4, the subject matter of Example 2 may optionally be configured such that the electrode is separate from the target, and the electrode is made of uranium.

In Example 5, the subject matter of any one or any combination of Examples 1 to 4 may optionally be configured such that the voltage source includes a voltage generator and a voltage controller. The voltage generator is configured to generate the voltage signal. The voltage controller is configured to control the generation of the voltage signal for at least one of reducing chemical reaction between the uranium of the target and materials in the MS fuel or reducing accumulation of materials on the target.

In Example 6, the subject matter of any one or any combination of Examples 1 to 5 may optionally be configured to further include a beam pipe coupled to the reactor and a superconducting radio-frequency linear particle accelerator coupled to the beam pipe and configured to generate the proton beam to be injected into the reactor through the beam pipe to strike the target.

In Example 7, the subject matter of any one or any combination of Examples 1 to 6 may optionally be configured to include multiple reactors including the accelerator-driven subcritical nuclear reactor and one or more additional accelerator-driven subcritical nuclear reactors each configured to operate using MS fuel and including a target positioned to receive a proton beam and to be cooled by the MS fuel. The multiple reactors are each coupled to the superconducting radio-frequency linear particle accelerator to receive the proton beam from the accelerator-driven subcritical nuclear reactor.

In Example 8, the subject matter of Example 7 may optionally be configured such that the multiple reactors are each a small modular reactor.

In Example 9, the subject matter of any one or any combination of Examples 1 to 8 may optionally be configured to further include a fuel processing plant configured to receive spent nuclear fuel and to produce the MS fuel using the spent nuclear fuel.

In Example 10, the subject matter of any one or any combination of Examples 1 to 9 may optionally be configured to further include means for removing volatile radioactive fission products from the MS fuel continuously during operation of the reactor to maintain an amount of the volatile radioactive fission products in the reactor below a threshold corresponding to a safety limit for accidental release of radioactive materials.

An example (“Example 11”) of a method for nuclear power generation is also provided. The method includes: operating an accelerator-driven subcritical nuclear reactor using MS fuel, including striking a target positioned with a proton beam and cooling the target using the MS fuel; generating a voltage signal; and transmitting the voltage signal to an electrode in contact with the MS fuel in the reactor. The voltage signal is suitable for controlling corrosion of the target and one or more other portions of the reactor that are in contact with the MS fuel.

In Example 12, the subject matter of Example 11 may optionally further include providing a uranium target to be the target.

In Example 13, the subject matter of delivering the voltage signal to the electrode as found in Example 12 may optionally include delivering the voltage signal to a uranium electrode.

In Example 14, the subject matter of Example 13 may optionally include using the target as the electrode, and the subject matter of delivering the voltage signal to the electrode as found in Example 3 may optionally include delivering the voltage signal to the target.

In Example 15, the subject matter of any one or any combination of Examples 11 to 14 may optionally further include removing volatile radioactive fission products from the MS fuel continuously during operation of the reactor, including producing a side stream of the MS fuel flowing out of the reactor, separating the light fission products from the actinides, and returning the actinides to the reactor. The side stream includes light fission products and actinides. The actinides include uranium.

In Example 16, the subject matter of any one or any combination of Examples 11 to 15 may optionally further include: passing helium flows over the MS fuel in the reactor to remove volatile fission products from the MS fuel; and extracting one or more isotopes from the removed volatile fission products using fractional distillation.

In Example 17, the subject matter of any one or any combination of Examples 11 to 16 may optionally further include controlling the generation of the voltage signal for at least one of reducing chemical reaction between the uranium of the target and materials in the MS fuel or reducing accumulation of materials on the target.

In Example 18, the subject matter of any one or any combination of Examples 11 to 17 may optionally further include: generating the proton beam using a superconducting radio-frequency linear particle accelerator; splitting the proton beam generated by the superconducting linear particle accelerator into multiple proton beams; and operating multiple small modular reactors each being an instance of the accelerator-driven subcritical nuclear reactor, including injecting each proton beam of the multiple proton beams into a reactor of the multiple small modular reactors.

In Example 19, the subject matter of Example 18 may optionally further include manufacturing the multiple small modular reactors in one or more factories remote from a site of the nuclear power generation.

In Example 20, the subject matter of any one or any combination of Examples 11 to 19 may optionally further include producing the MS fuel by processing spent nuclear fuel resulting from operation of one or more light water reactors.

This Summary is an overview of some of the teachings of the present application and not intended to be an exclusive or exhaustive treatment of the present subject matter. Further details about the present subject matter are found in the detailed description and appended claims. Other aspects of the disclosure will be apparent to persons skilled in the art upon reading and understanding the following detailed description and viewing the drawings that form a part thereof, each of which are not to be taken in a limiting sense. The scope of the present disclosure is defined by the appended claims and their legal equivalents.

### BRIEF DESCRIPTION OF THE DRAWINGS

The drawings illustrate generally, by way of example, various embodiments discussed in the present document. The drawings are for illustrative purposes only and may not be to scale.

FIG. 1 illustrates an embodiment of a nuclear power generation system including an accelerator-driven molten salt (MS) fueled reactor with corrosion control.

FIG. 2 illustrates an embodiment of an underground placement of a nuclear power generation system, such as the system of FIG. 1.

FIGS. 3A and 3B each illustrate an embodiment of an apparatus for corrosion control in a nuclear power generation system, such as the system of FIG. 1, with FIG. 3A illustrating an embodiment using a target as an electrode for corrosion control and FIG. 3B illustrating an embodiment using an electrode separate from the target for corrosion control.

FIG. 4 illustrates an embodiment of a method for corrosion control in a nuclear power generation system.

FIG. 5 illustrates an embodiment of a system for continuous removal of fission products from an MS fueled nuclear reactor, such as the reactor in FIG. 1, while the reactor is operating.

FIG. 6 illustrates an embodiment of a method for continuous removal of fission products from an MS fueled nuclear reactor that can be performed within the containment enclosing the reactor while the reactor is operating.

### DETAILED DESCRIPTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized, and that structural, logical and electrical changes may be made without departing from the spirit and scope of the present invention. References to “an”, “one”, or “various” embodiments in this disclosure are not necessarily to the same embodiment, and such references contemplate more than one embodiment. The following detailed description provides examples, and the scope of the present invention is defined by the appended claims and their legal equivalents.

The present disclosure discusses, among other things, method and apparatus using uranium electrodes for controlling corrosion of reactor components and internal spallation targets in an MSR, such as the Mu*STAR. Mu*STAR is discussed, for example, in Rolland Johnson et al., “Mu*STAR: A Modular Accelerator-Driven Subcritical Reactor Design”, Proceedings of the 10th Int. Particle Accelerator Conf. (IPAC2019), Melbourne, Australia (May 2019), 3555-3557, which is incorporated herein by reference in its entirety.

Mu*STAR systems can be constructed at light-water reactor (LWR) sites that store spent nuclear fuel (SNF), also known as used nuclear fuel (UNF), to augment or replace the existing reactors. Mu*STAR can convert the used fuel to cost-competitive energy while reducing the radiotoxic lifetime of the waste stream from about a hundred thousand years to a few hundred years. Many jurisdictions now prohibit the licensing of new nuclear plants until a national strategy has been established for the long-term disposal of their nuclear waste. Mu*STAR can be used as part of that strategy to enable construction of new nuclear facilities that are especially important to address climate change.

The present subject matter relates to an accelerator-driven subcritical high-power molten salt fueled reactor designed to consume SNF. The advantages of subcritical operation and continuous removal of volatile radioisotopes, with continuous monitoring of reactivity and accidental radioisotope release inventory, can make government (e.g., the U.S. Nuclear Regulatory Commission) licensing fast and affordable enough for modifications to designs that allow for technical evolution including constant improvements, for example, by following Deming's principles. “Dr Deming Point 5 Constant Improvement”, https://www.quality-assurance-solutions.com/Deming-Point-5.html.

When combined with other technological innovations, an accelerator-driven molten salt fueled reactor is uniquely suited to consume SNF to provide the most economical heat source for many applications. In an example, in a 2 GWe Nuclear Power Plant, one accelerator drives 10 small modular reactors (SMRs).

The design of Mu*STAR was conceived as a combination of two remarkable Oak Ridge National Laboratory (ORNL) accomplishments, the 1 GeV Superconducting Linac of the Spallation Neutron Source (SNS) and the 1965-1969 Molten Salt Reactor Experiment (MSRE). The combining mechanism for these two technologies is a spallation target in the middle of the reactor that produces neutrons that initiate decay chains that produce heat as they die out in the subcritical core.

A problem in molten-salt (MS) reactors is the corrosion of their internal components due to the highly corrosive nature of the molten salts. Existing methods for controlling corrosion of reactor components include adding chemicals (e.g., adding beryllium in the MSRE). The present subject matter uses an electrode with a controllable voltage to control the corrosion. In various embodiments, a voltage can be applied to a uranium target to control its corrosion, a voltage can be applied to an electrode (which is other than the target and can be made of uranium or another suitable electrode material) to control corrosion of reactor components (e.g., vessel, heat exchangers, etc.), or the uranium target can be used as the an electrode to control its own corrosion and the corrosion of the reactor components. While using an electrode (the spallation target or another electrode) made of uranium for corrosion control is specifically discussed as an example in this disclosure, various embodiments of the present subject matter can use the spallation target and/or one or more electrodes made of one or more suitable metals to control the corrosion of the target and/or various components of the MS reactor.

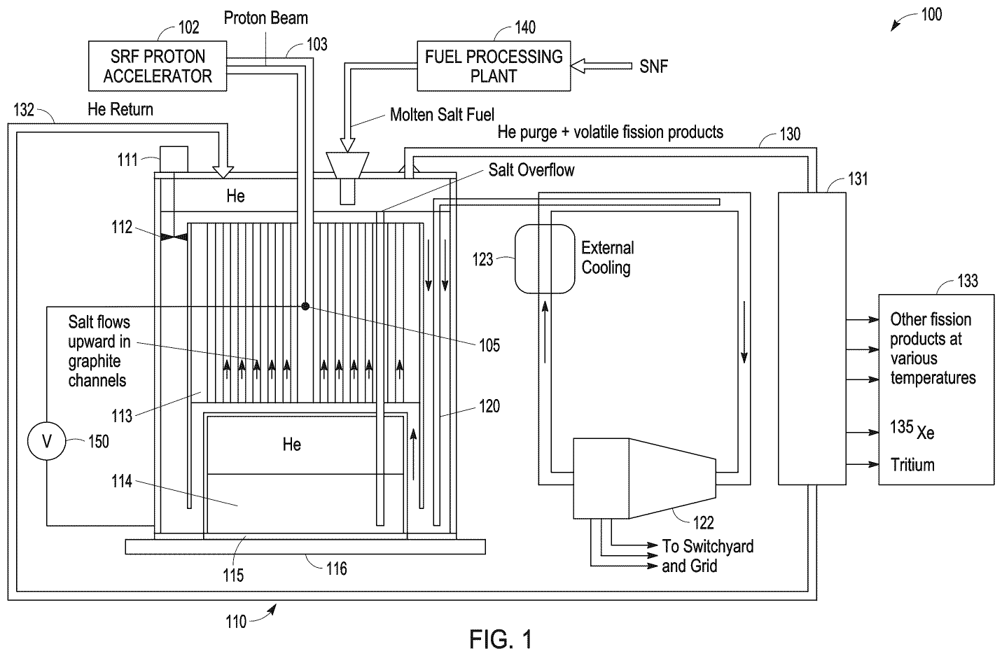

FIG. 1 illustrates an embodiment of a nuclear power generation system 100 including an accelerator-driven MS fueled reactor 110 with corrosion control. System 100 can generate electricity while removing volatile elements from circulating helium cover or sparge gas by fractional distillation. System 100 as illustrated can represent an example of a single-SMR version of a Mu*STAR Nuclear Power Plant (NPP). Reactor 110 can be driven by superconducting radio-frequency (SRF) proton accelerator 102, which has sufficient power to generate a proton beam that can be split into proton beams to drive multiple SMRs simultaneously.

Reactor 110 includes a vessel 115 (e.g., made of modified Hastelloy-N or another corrosion resistant material, such as stainless steel alloys) that encloses components of the reactor core and all the MS fuel in the reactor. Vessel 115 is placed on a steel base plate 116 and has no penetrations below liquid level. The MS fuel never leaves system 100 during operation of reactor 110. An internal target 105 (e.g., a uranium spallation target) is positioned in the middle of reactor 115. A beam pipe 103 is coupled between accelerator 102 and target 105 to guide the proton beam generated by accelerator 103 to target 105. Electric motors 111 and MS fuel pumps 112 (one of each shown in FIG. 1) are positioned around the circumference of vessel 115 for circulating the MS fuel within reactor 110. A graphite moderator 113 includes graphite channels through which the MS fuel can flow upward in the graphite channel. A storage tank 115 is provided at the bottom of vessel 115 for storing the MS fuel in reactor 110.

A non-radioactive MS loop heat exchanger 120 provides a thermal link between reactor 110 and a turbine-generator 122 positioned outside of reactor 110. Turbine-generator 122 can generate steam using the heat produced by reactor 110, produce a revolving motion using the flow of the steam, and generate electricity by converting mechanical energy of the revolving motion into electrical energy. The generated electricity can be delivered to a power grid through a switchyard. Operation of accelerator 102 can be powered using a portion of the electricity generated by turbine-generator 122. An external cooling system 123 can cool the steam after it is used by turbine-generator 122 to produce electricity.

A fractional distillation column 131 can receive helium (He) purge and volatile fission products from reactor 100 through a helium purge and volatile fission products conduit 130 and returns the He to reactor 110 through a helium return conduit 132. Fractional distillation column 131 can produce tritium, xenon-135 (¹³⁵Xe), and other fission products at various temperatures from the volatile fission products using fractional distillation. An fission product storage 133 can be placed underground to receive and store these products of the fractional distillation column.

System 100 operates using SNF, such as SNF produced by one or more LWRs. A fuel processing plant 140 produces the MS fuel for operating reactor 110 by processing the SNF. The SNF can be directly from a LWR and/or from a nuclear waste storage storing the SNF from the LWR.

During the operation of system 100, helium flows over the surface of the hot salt to remove volatile isotopes and carry them to a hot cell where they are separated out chemically and/or cryogenically with fractional distillation column unit 131, and then safely stored underground while they decay. This reduces the inventory of volatile isotopes in the reactor by a factor of almost a million compared to reactors like those at Fukushima. This also permits continuous harvesting of valuable isotopes such as tritium and Xe-133 as well as unwanted isotopes like iodine-131 and Xe-135.

Under steady state operation of system 100, the MS fuel is fed in at the same rate that it flows out through the salt overflow tube into storage tank 114 located below the reactor core. In this situation, reactor 110 would burn around 25 g of fissionable material (U-235 and Pu-239) per hour for around 40 years. At that time, the MS fuel in storage tank 114 can be pumped by helium pressure into a second reactor to operate with a higher power beam for another 40 year cycle. After a total of 5 such 40-year cycles, it would take more than 15% of the electricity produced by the reactor to drive the accelerator; the fuel can be reprocessed or put into long-term storage with reduced radiotoxicity.

Target 105 can be much simpler to operate than that used at the ORNL Spallation Neutron Source in that the proton beam in that facility is required to be pulsed at extremely high power and tightly focused such that shock phenomena quickly destroy any simple solid metal target. In the case of Mu*STAR, the proton beam can be diffuse or rastered on the target and the 700° C. molten salt fuel can be used to cool the target.

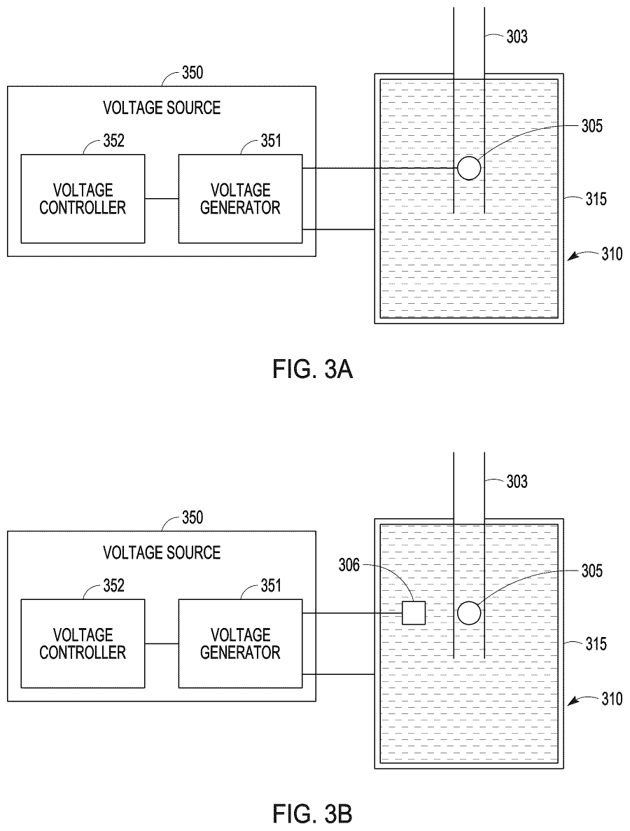

System 100 can include an apparatus for corrosion control including a voltage source 150 electrically coupled to target 105 and/or one or more electrodes. Voltage source 150 can generate a voltage signal suitable for reducing or eliminating corrosion of various components of reactor 110. The apparatus for corrosion control is more specifically discussed below, with reference to FIGS. 3A and 3B.

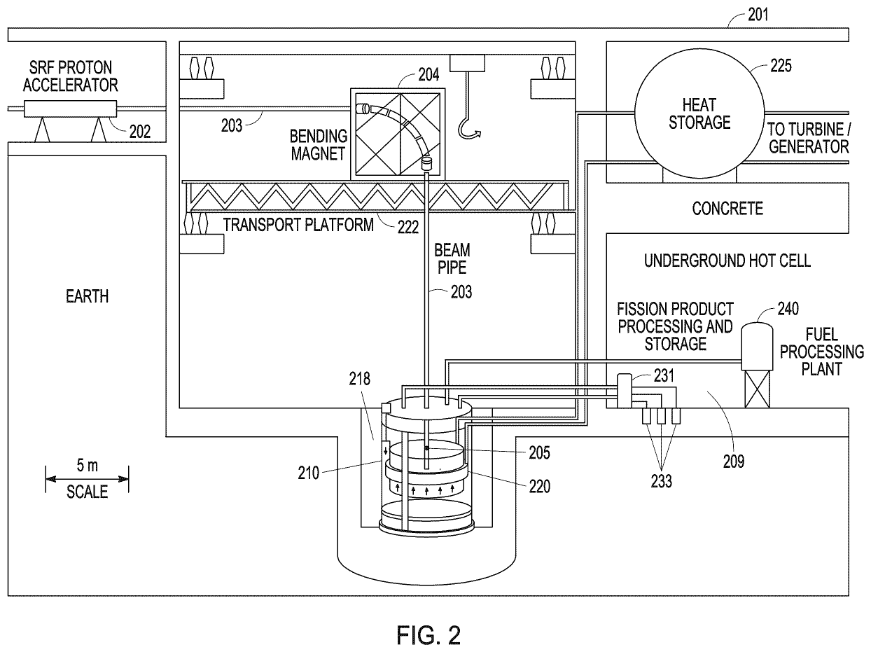

FIG. 2 illustrates an embodiment of an underground placement of a nuclear power generation system 200. System 200 can represent an example of system 100 when deployed in a NPP site, with the addition of a non-radioactive MS energy storage system to cover interruptions in reactor or accelerator operation and the addition of an underground hot cell to allow for conversion of solid SNF fuel rods into fluoride salts, fission product processing and storage, and preparation of fission product remnants for burial. Portions of system 200 as shown in FIG. 2 are enclosed in a reactor containment 201 (e.g., a concrete containment). Components of system 200 as shown in FIG. 2 include a superconducting radio-frequency (SRF) proton accelerator 202, a reactor 210 including an internal spallation target 205 and a heat exchanger 220, passive cooling channels 218, beam pipes 203, a bending magnet 204, a transport platform 222, a heat storage 225, a hot cell 209 enclosing a fission product processing unit 231, a processed fission product storage 233, and a fuel processing plant 240. In various embodiments, these components can be manufactured in one or more factories and installed in the LWR site to receive SNF from the LWR. The 5-meter (5 m) scale is shown in FIG. 2 to provide a general illustration of dimensions of the power generation system by way of example, but not by way of restriction. System 200 can also include an apparatus for corrosion control (not shown in FIG. 2) such as discussed above, with reference to FIG. 1, and more specifically discussed below, with reference to FIGS. 3A and 3B.

Accelerator 202 can be an example of accelerator 102. Reactor 210 can be an SMR, such as an example of reactor 110. Accelerator 202 can generate a proton beam, which is guided through beam pipes 203 and bending magnet 204 to be injected into reactor 210 to strike internal spallation target 205, which can be a heavy metal, such as uranium, target. Heat exchanger 220 can be an example of heat exchanger 120 and can receive thermal energy resulting from the reaction in reactor 210 to be transmitted to heat storage 225, which is an intermediate heart storage between reactor 210 and the turbine-generator that converts the thermal energy to electrical energy. Transport platform 222 can move bending magnet 204 and beam pipes 203 out of way for maintenance of reactor 210. Hot cell 209 includes the system components for converting spent nuclear fuel oxide to fluoride and fission product removal and for preparing the fuel. Fission product processing unit 231 can include a separation device that can isolate light fission products from a side stream of MS fuel flowing out of reactor 210. As shown in FIG. 2, fission product processing unit 231 can receive the side stream of MS fuel from reactor 210 through a side stream conduit and returns a processed (i.e., treated) fuel stream including actinides to reactor 210 through a treated side stream conduit. Processed fission product storage 233 can include multiple storage devices for storing isotope products produced by fission product processing unit 231 and waste extracted by fission product processing unit 231 to be removed from containment 201. Fuel processing plant 240 can prepare the MS fuel to be transmitted to reactor 210 through a fuel pipe. When accelerator 202 is not operating, air is circulated through passive cooling channels 218 for decay heat. There is no water, steam, or Zr inside reactor containment 201.

FIGS. 3A and 3B each illustrate an embodiment of an apparatus for corrosion control in a nuclear power generation system, such as system 100 or 210. The nuclear power generation system includes a reactor 310, which is an accelerator-driven subcritical nuclear reactor that operates using MS fuel and can represent an example of reactor 110 or 210. Reactor 310 includes a target 305 positioned to be struck by a proton beam generated by an SRF proton accelerator and injected into reactor 310 through a beam pipe 303. Reactor 310 has a vessel 315 that encloses molten salts used as the fuel for the reactor and also used to cool target 305. An electrode for corrosion control is positioned in reactor 310 to be in contact with the MS fuel in the reactor. A voltage source 350, which can represent an example of voltage source 150, is electrically coupled to the electrode. Voltage source 150 can generate a voltage signal to be applied to the electrode. The voltage signal is suitable for controlling corrosion of target 305 and one or more other portions of the reactor that are in contact with the MS fuel. In various embodiments, the target is made of uranium.

FIG. 3A illustrates an embodiment using target 305 as the electrode for corrosion control. FIG. 3B illustrates an embodiment using an electrode 306 that is separate from target 305 for corrosion control. In various embodiments, electrode 306 is also made of uranium.

Voltage source 350 can include a voltage generator 351 and a voltage controller 352. Voltage generator 351 can generate the voltage signal. Voltage controller 352 can control the generation of the voltage signal. In various embodiments, the voltage signal can be controlled for reducing chemical reaction between the uranium of the target and materials in the MS fuel and/or for reducing accumulation of materials on the target.

Target 305 can be cooled by the MS fuel. Uranium is used as the target material because it provides the most neutrons per incident proton and is compatible with the MS fuel. If target 305 is corroded by the salt, additional fuel material, uranium, will be dissolved into the MS fuel without introducing a contaminant. In order to control this possible corrosion, the voltage can be applied on target 305, which is used as an electrode and connected to voltage source 350 with a wire, to control corrosion of the target and corrosion of the reactor vessel and all its components that come in contact with the MS fuel. In various embodiments, the electrode can also be a uranium electrode separate from the target and immersed in the MS fuel with a wire connecting the electrode to voltage source 350.

In one embodiment, target 305 is coated with silicon carbide (SiC), which is electrically conductive and known for having good resistance to chemical corrosion. This can be done in addition to, or in place of, applying the voltage signal on target 305 for the corrosion control.

In various embodiments, the electrode(s) (e.g., target 305 and/or other conductors) can each be connected to voltage source 350 using a wire. The wire is insulated for protection against the MS fuel. The voltage signal applied to the electrode can be adjusted, for example to allow (1) the uranium of the target or other electrode to be kept from being attacked by the chemicals in the MS (e.g. Fluorine) and/or (2) materials that have adhered to the target or other electrode to be reabsorbed by the MS or otherwise separated from the target or other electrode. By cycling in this manner, for example, materials can accumulate on an electrode that protects the target and components and then to be removed from the electrode. Corrosion of the uranium electrode can be controlled using a control scheme for preventing buildup of deposited salt species and can additionally be used to buffer the salt chemistry to prevent corrosion of other reactor components.

Fission of uranium is an oxidizing process that occurs in a uranium fluoride-fueled MSR. The charge of uranium that is fissioned, which is +4, is higher than the sum of the charges on all fission products, which is about +3.05. See, Baes C. F., Jr. “The Chemistry and Thermodynamics of Molten Salt Reactor Fuels” Journal of Nuclear Materials. 51 (1974) Pp. 149-162. This charge imbalance results in oxidation of salt facing materials, including the structural metals in reactor components, which could prevent safe operation of the MSR. Excess charge and the enhanced corrosivity of the salt due to fission can be controlled by buffering the salt redox. Corrosion control schemes based on consumption of beryllium and maintaining a low ratio of UF₃ to the UF₄ in the fuel have been proposed. See, Zhang, J., Forsberg C. W., Simpson, M. F., Guo, S., Lam, S. T., Scarlat, R. O., Carotti, F., Chan, K. J., Singh, P. M., Doniger, W., Sridharan, K., and Keiser, J. R. “Redox Potential Control in Molten Salt Systems for Corrosion Mitigation”. Corrosion Science, (2018) pp. 44-53. These methods of buffering the salt redox either change the fuel composition by introducing additional BeF₂ or can introduce contaminants to the salt. The use of a uranium metal electrode to maintain the salt redox in an MS avoids these detrimental effects.

The uranium electrode can reduce the corrosivity of the salt by using the excess charge to generate new UF₄ that functions as fuel rather than corroding structural materials. The controlled introduction of additional uranium to the salt can also prolong the lifetime of the fuel salt. If a uranium electrode is held at a constant voltage for the purpose of electrical protection, it can become a deposition site for other electrochemically active species or particulates in the salt that are detrimental to operation. The effect can be mitigated by periodic electrochemical cleaning of the electrode. Direct electrochemical control using a uranium metal electrode can provide chemistry control for an MS reactor system without introducing contaminants to the salt. An electrical protection and cleaning procedure for a uranium metal electrode in a uranium fluoride salt can be developed and optimized to reduce risk for the deployment of reactor 305 in a nuclear power generation system such as system 100 or 200.

Approximately 500 g of salt having specified salt composition can be synthesized by mixing, heating and fusing commercially available component salts. The composition of the prepared salt can be characterized by using spectroscopic methods. The electrochemical behaviors of the fuel salt and an immersed uranium electrode can be measured by using electroanalytical methods including cyclic voltammetry, linear sweep voltammetry and open circuit potential measurements. Electrochemical behavior of the uranium electrode can be determined using polarization and open circuit potential measurements. Tests can be conducted for one and three months to demonstrate the effect of not controlling the voltage of the uranium electrode. Then, appropriate voltage control schemes can be developed that maintain the integrity of the uranium electrode during salt immersion based on modeling, polarization, and multi-electrode sensor array measurements. The effectiveness of the voltage control scheme can be verified using electrochemical corrosion measurement techniques such as linear polarization sweeping and electroanalytical measurements with the Argonne multi-electrode sensor array. After the electrochemical testing, the uranium electrodes can be examined using scanning electron microscopy (SEM) analysis, and the salt properties can be characterized by using differential scanning calorimetry and spectroscopic methods to measure the effect of the redox control scheme on the salt chemistry.

Existing divisional capabilities and expertise in thermochemical and electrochemical property measurements can be used to study the effects of salt chemistry over the lifetime of the specified fuel salt, including the impact on the uranium electrode. Results of the study can be used to optimize a voltage control scheme that can be used to control the salt chemistry within the operating range while ensuring the integrity of the uranium electrode.

The use of a uranium electrode to buffer the chemistry of molten salt in UF₄-containing systems has been proposed previously but has not been applied due to confounding electrochemical effects. A voltage control scheme can be developed to implement this approach without generating detrimental deposits on the electrode, thereby providing MSRs with an advantage in controlling salt chemistry with additions of metallic uranium.

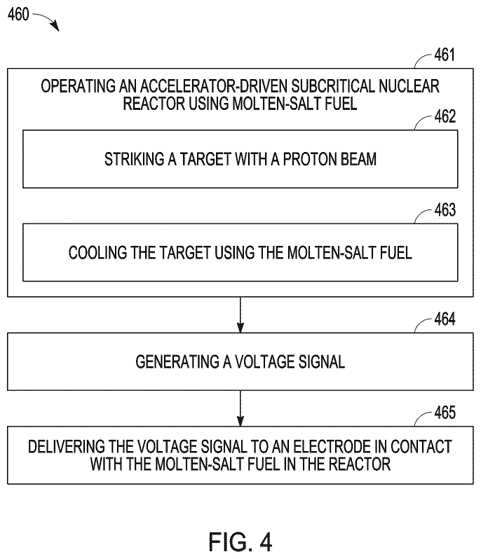

FIG. 4 illustrates an embodiment of a method 460 for corrosion control in a nuclear power generation system, such as system 100 or 200. In various embodiments, method 460 can be performed using the apparatus for corrosion control as illustrated in FIG. 3A or 3B.

At 461, an accelerator-driven subcritical nuclear reactor is operated using MS fuel. The MS fuel used for operating the reactor can be produced by processing spent nuclear fuel resulting from one or more LWRs. The operation can include striking a target positioned with a proton beam at 462 and cooling the target using the MS fuel at 463. A uranium target can be provided to be the target, which can be a spallation target or another type of target. The proton beam can be generated using a superconducting linear particle accelerator. In various embodiments, the proton beam generated by the superconducting linear particle accelerator can be split into multiple proton beams, and multiple SMRs (e.g., multiple instances of the accelerator-driven subcritical nuclear reactor) can be operated by injecting each proton beam of the multiple proton beams into a reactor of the multiple SMRs. The SMR(s) can be manufactured in one or more factories remote from a site of the nuclear power generation and transported to the site for installation.

At 464, a voltage signal is generated. The voltage signal is suitable for controlling corrosion of the target and one or more other portions of the reactor that are in contact with the MS fuel. The generation of the voltage signal can be controlled for reducing chemical reaction between the uranium of the target and materials in the MS fuel and/or reducing accumulation of materials on the target.

At 465, the voltage signal is transmitted to an electrode in contact with the MS fuel in the reactor. The electrode can be a uranium electrode. In one embodiment, the target is used as the electrode. In another embodiment, an electrode other than the target is positioned in the reactor to be in contact with the MS fuel. In various embodiment, the voltage signal can be transmitted to one or more electrodes including the target and/or one or more electrodes other than the target.

The present subject matter can be applied in an MS-fueled subcritical nuclear reactor system that converts SNF to MS fuel and uses contactors or vortex separators to extract fission products (FPs) while leaving actinides in the core to be completely consumed. The removal of many FP neutron poisons can improve the efficiency of the reactor by keeping the flux of neutrons high and the power needed to drive the accelerator low. One example of such a system is discussed in U.S. patent application Ser. No. 18/055,764, “CONTINUOUS REMOVAL OF FISSION PRODUCTS FROM MOLTEN-SALT FUELED NUCLEAR REACTORS”, assigned to Muons Incorporated, filed on Nov. 15, 2022, now published as US 2023/0154636 A1, which is incorporated herein by reference in its entirety. This system is based on methods of separation of MS components, including separation by mass of volatilized MS fuel or by liquid-liquid contact methods using liquid metal, and can be applied to critical reactors, subcritical reactors including accelerator-driven subcritical reactors, or other types of reactors fueled by molten salts containing dissolved fissile and/or fertile materials including SNF, including any past, present, or future reactors. Actinides remain in the reactor to produce profitable energy and be transmuted while the extracted FPs can be buried without long-lived actinides such that a geologic repository is not necessarily needed to close the nuclear fuel cycle. In particular, by removing neutron-absorbing FPs and operating subcritically, where the restrictive link between operation and criticality is broken, complete burnup of the SNF can be achieved. Implementing this separation approach in a subcritical reactor is discussed in this document as an example of application of the present system, which can be applied to various subcritical and non-subcritical reactors. The system continuously processes the MS inside the reactor while the reactor operates, without the need for a separate plant. This simultaneously improves the neutronics of the reactor, increasing the burnup of the fuel and extending its useful life for generating energy.

Besides the method of separation of actinides by mass or using a liquid metal medium to isolate non-volatile FPs, a helium purge can be used to remove volatile FPs at normal operating temperature such that the inventory of volatile radioactive isotopes in the core can be reduced by orders of magnitude compared to solid-fuel systems. This feature, with subcriticality, may allow for fewer regulatory burdens for construction and operation, as well as popular acceptance. The present system is a dramatically simpler and cost-effective solution to the SNF problem when compared to existing systems, and provides intrinsic proliferation resistance by not removing fissile material from the core containment, and not requiring enriched uranium for operation. This transformative solution to use the enormous remaining energy in the fertile U-238 of the SNF while economically disposing of the mostly short-lived remnants is best enabled by an accelerator-driven subcritical reactor leveraging decades of groundbreaking technological developments of superconducting radio-frequency (RF) cavities needed for the neutron-producing accelerator.

A subcritical reactor is a nuclear fission reactor that produces fission without the need for criticality (k_{eff}<1). Instead of a self-sustaining chain reaction, an accelerator-driven subcritical reactor uses an accelerator to provide neutrons for subcritical operation of the reactor (where the output power is proportional to the beam power, also referred to as an “energy amplifier”). An example of the accelerator-driven subcritical reactor is the Mu*STAR. The accelerator-driven subcritical reactor is enclosed in a reactor containment (also referred to as containment building, containment shell, containment vessel, or the like) that is designed to prevent or limit FPs produced by operation of the reactor from being released into the environment.

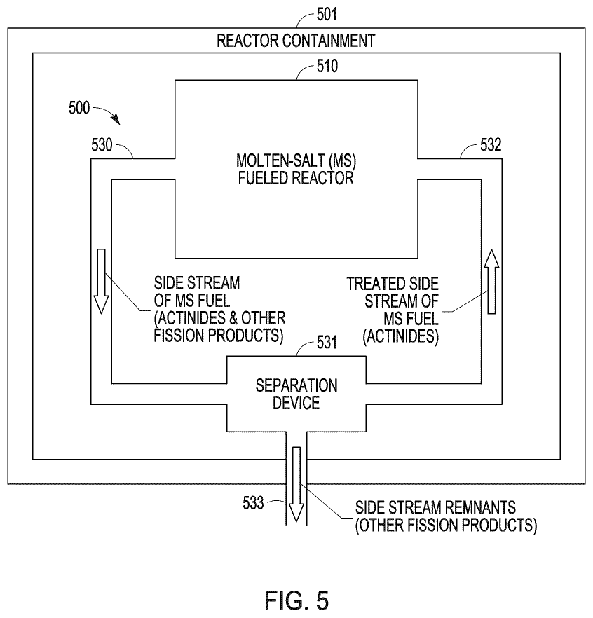

FIG. 5 illustrates an embodiment of a system 500 for continuous removal of fission products from an MS fueled nuclear reactor 510 enclosed in a reactor containment 501. Reactor 510 can be a critical reactor or an accelerator-driven subcritical reactor (e.g., reactor 110). System 500 can represent an example of portions of system 100 or 200 and includes a side stream conduit 530 coupled to reactor 510 and positioned within reactor containment 501, a separation device 531 coupled to conduit 530 and positioned within reactor containment 501, a treated side stream conduit 532 coupled between separation device 531 and reactor 510 and positioned within reactor containment 501, and a fission product conduit 533 coupled to separation device 531. Conduit 530 can receive a side stream of an MS fuel flowing out of reactor 510 while reactor 510 is operating. The received side stream includes actinides and other fission products. Separation device 531 can receive the side stream from conduit 530 and treat the received side stream to produce isolated actinides and side stream remnants. The side stream remnants include the other fission products without the isolated actinides. Conduit 532 can feed the treated side stream including the isolated actinides back into reactor 510 for power generation and destruction of the isolated actinides in reactor 510. Fission product conduit 533 allows for removal of the side stream remnants from reactor containment 501 while reactor 510 is operating.

In one embodiment, separation device 531 uses a method to extract volatile radiotoxic elements from the circulating MS fuel. For example, the MS fuel can be sprayed from a nozzle to increase the MS surface area and thereby the evaporation rate of the volatiles. This technique was used in the MSRE, where the removed gases were vented to a tall stack to be released into the atmosphere.

In one embodiment, separation device 531 includes a mass separation device that can volatilize the fuel in the received side stream and separate the actinides by mass using centrifugation. Examples of such a mass separation device include a vortex separator and a Tesla-valve based separator (a modified Tesla valve). In another embodiment, separation device 531 includes a liquid-metal separation device that introduces a molten metal into the received side stream. The actinides and other FPs in the received side stream migrate to a contactor containing the liquid-metal. The liquid metal reduces actinides and other FPs that are separable by established chemical methods. The actinide fraction is transferred to a carrier MS for reinjection into the reactor. The remnant FPs are similarly removed. In various embodiments, separation device 531 can perform any method of separation discussed in this document. In various embodiments, separation device 531 can produce the side stream remnants with the fission products having a radiotoxicity lifetime for which a geological repository is not required. The separation of the isolated actinides and side stream remnants as performed by separation device 531 can be performed within containment 501 without interrupting the operation of reactor 510, allowing for safe, continuous removal of the fission products without the need of a separate plant. In various embodiments, separation device 531 can produce the side stream remnants with the fission products having a radiotoxicity lifetime for which a geological repository is not required.

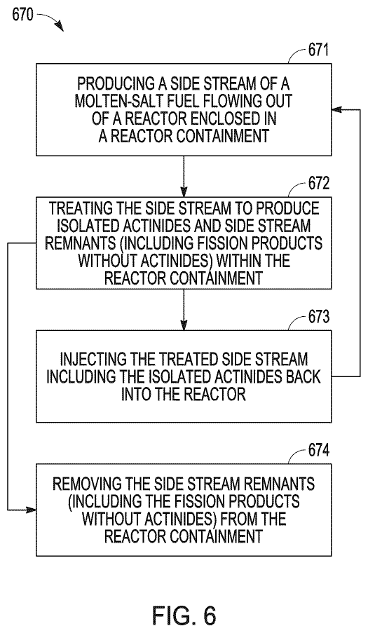

FIG. 6 illustrates an embodiment of a method 670 for continuous removal of fission products from an MS fueled nuclear reactor (e.g., reactor 510) that can be performed within the containment enclosing the reactor (e.g., containment 501) while the reactor is operating. In various embodiments, method 670 can be performed using system 500, which can be part of system 100 or 200. In various embodiments, methods 460 and 670 can be performed concurrently in the same nuclear power generation system.

At 671, a side stream of an MS fuel flowing out of the reactor is produced. The side stream includes actinides and other fission products and allows for continuous access to the fuel within the reactor containment while the reactor is operating.

At 672, the side stream is treated to produce isolated actinides and side stream remnants within the reactor containment. Examples of the actinides include uranium (U), plutonium (Pu), americium (Am), and curium (Cm). The side stream remnants include fission the other products (e.g., lanthanides).

In one embodiment, the treatment of the side stream includes separation by mass. The fuel in the side stream is volatilized, and the isolated actinides and side stream remnants are separated from each other by mass using centrifugation. The separation by mass can be performed, for example, using a vortex separator or a Tesla-valve based separator.

In another embodiment, the treatment of the side stream includes use of molten metal. An example of the molten metal that can be used for this purpose is bismuth. See, for example, L. M. Ferris F. J. Smith, J. C. Mailen, M. J. Bell, “Distribution of lanthanide and actinide elements between molten lithium halide salts and liquid bismuth solutions,” J. Inorg, Nucl. Chem., Vol. 34, 1972, 2921-2933. Another example of the molten metal that can be used for this purpose is aluminum. See, for example, O Conocar, N. Douyere, J. Lacquement, “Extraction behavior of actinides and lanthanides in a molten fluoride/liquid aluminum system,” J. Nucl. Materials, Vol. 344 (1-3), 2005, 136-141.

At 673, the treated side stream including the isolated actinides is injected back into the reactor for power generation and destruction of the isolated actinides in the reactor. This increases fuel efficiency and the efficiency of the reactor as the fuel does not need to be removed from the reactor containment to be reprocessed.

At 674, the side stream remnants are removed from the reactor containment. This can be done without interrupting the operation of the reactor. In various embodiments, the side stream remnants separated from the side stream have a radiotoxicity lifetime for which a geological repository is not required. Such a radiotoxicity lifetime can be around 300 years before it reaches that of uranium ore. This facilitates processing of fission products to prevent their weaponization, ensure nonproliferation, and provide safeguards (material accountancy).

In various embodiments, after being removed from the reactor containment, the side stream remnants including the fission products can be processed to extract one or more isotopes that can be used, for example, for medical applications including therapeutical and/or diagnostic uses.

System 500 and method 670 can be applied to nuclear power generation with substantially increased efficiency, decreased cost, and increased safety when compared to existing nuclear power generation systems. Various aspects of system 500 and method 670 are further discussed below.

The separation between actinides and volatilized fission products can be done by mass rather than by chemical means. In an MS fueled reactor like the ORNL molten-Salt Reactor Experiment (MSRE), a side stream of fuel can be split off within the reactor containment, heated to volatilize all components, and separated into components as a function of mass using known diffusion or centrifugal techniques. In one scheme the low-mass band of the carrier salt is separated first, followed by the high-mass band of actinides. These are returned to the reactor, and the middle band thus remaining, largely fission products, collected and ultimately removed. In practice, the eutectic nature of the salt may alter how the vapor phases evolve and alter this simple model.

The fission products, which include mostly short-lived isotopes and no actinides, then can be removed from the reactor for permanent burial without needing a geologic repository to close the fuel cycle. The actinides, which stay in the MS fuel, can continue to be both bred, and burned in the reactor. With an accelerator-driven subcritical reactor where the restrictive link between operation and criticality is broken, the burning can continue for very deep burns of all the fertile and subsequent fissile materials. Nearly complete burnup and very inexpensive power can be expected such that SNF becomes a commodity fuel rather than waste to be buried.

In short, continuously removing the FPs from an operating reactor and leaving the actinides in it allows (1) deep burns because fission-product neutron poisons are removed, and (2) FPs to be buried without geologic requirements because they are not mixed with actinides. There are even more advantages with a subcritical reactor that are discussed below.

The present subject matter can simultaneously solve the problems of, among other things, accumulated SNF, expensive nuclear power, and climate change related to nuclear power generation. Issues such as what happens when fluorinated SNF fuel in a eutectic carrier salt is heated to high temperatures to volatilize it can be resolved by, for example, (1) measuring the rates of volatilization for components of the MS fuel as a function of temperature, (2) develop concepts for vortex/centrifugal or diffusion systems to do mass separation in the extreme environment near an active nuclear core, especially taking advantage of additive manufacturing techniques, (3) prototyping a mass separation device, (4) computational support for the design and prototype, and (5) simulating the effects of the FP removal on reactor dynamics for the Mu*STAR accelerator-driven subcritical reactor.

It is believed that the most responsible method to close nuclear fuel cycles and produce the lowest volume of radiolytic waste product is through the transmutation of the actinide population(s) in unwanted nuclear materials (NM) such as used-fuel or plutonium. A common benefit that is often cited for MS reactors is the reduced need to refuel the reactor for extended periods of time. For reactor types that would burn unwanted used fuel or plutonium, resupply of the fissile NM is necessary. Depending on the reactor type, deeper burn times may be required to transmute actinide populations prior to a subsequent refueling with the unwanted NM. For all MS reactor types, neutron poisons grow in and increasingly conflict with the extended operation of the reactor. Additionally, the increase in the general FP population becomes a radiolytic burden on the materials of construction. Radiolysis of the fuel salt is oxidative overall and contributes to an evolution of corrosion mechanisms that are time, salt and reactor type dependent. Moreover, radiolytic embrittlement of functional reactor parts is life-threatening to extended operations. Thus a method to address the growth of FPs in MS reactors and prevent their overgrowth is on a critical path towards: (1) closing the nuclear fuel(s) cycle of MS reactors with a minimized radiolytic waste product, and (2) the general development of all molten-salt technologies.

There are two approaches historically considered for removal of the largest source of neutron poisons, the lanthanides, from an MS fuel. Prior to the operation of the MSRE, the MS reactor campaign advanced bench scale methods for the reductive extraction of the lanthanides in liquid bismuth (Bi) from the MS: LiF—BeF₂—ZrF₂ (65-30-5 mole %). L. M. Ferris F. J. Smith, J. C. Mailen, M. J. Bell, Distribution of lanthanide and actinide elements between molten lithium halide salts and liquid bismuth solutions, J. Inorg, Nucl. Chem., Vol. 34, 1972, 2921-2933. Procedures for stripping the metallic FPs from the liquid Bi for their disposal were developed. The liquid Bi extraction of trivalents (the lanthanides, Am, Cm, PuF3) was demonstrated at bench scale during the MSR campaign, including not only extraction by the liquid Bi, but also their recovery from it. This was done with mixer settler type equipment rather than centrifugal contactors or otherwise. This type of contactor set up generally (e.g., for plutonium uranium reduction extraction (PUREX)) uses a set of contactors. The MS flows to each contactor. Each contactor has a separate function. Such setups exist at Pacific Northwest National Laboratory (PNNL) for PUREX-like separations. They are all rigged up with ultra-violet (UV) and Raman spectroscopy for online monitoring of the comings and goings of various species. A similar set of contactors can be used to isolate the actinides from the liquid bismuth. Significantly, these methods may be generally applicable to several MS reactor types. A downside of this general approach is that a side stream of the fuel salt would be passed to a fuel processing facility nearby the reactor. In the case of the MSRE, this would have required a shutdown of the reactor for transfer of the fuel salt, or at least smaller volumes of it, from the reactor. Trivalent plutonium would be extracted with the lanthanides. Since the plutonium would be outside the reactor containment, a potential for its removal is inherent in the method.

An alternative approach was distillation of the salt. R. B. Briggs, M S reactor program. Progress report for the period ending Feb. 28, 1966. ORNL-3936, 1966. It was recognized that the vapor pressures of the lanthanide fluorides are fairly low, that is their boiling points are above 2200° C., whereas the vapor pressure of LiF—BeF₂—ZrF₂ is such that it can be distilled near 1000° C. Consequently, it was envisioned that the salt might simply be distilled from an entire class of FPs and this represents a major win. However, problems still revolve around (1) discontinuous reactor operation and (2) proliferation.

To address such issues, the present subject matter provides mass-based, and temperature-assisted gas phase methods that can remove FPs from MS fuel during reactor operation without the removal of large process volumes from the reactor containment. In effect, the large external fuel reprocessing units as proposed in the MS reactor campaign can be replaced by small units placed inside the reactor containment. Separating just the fission products and keeping the actinides inside the reactor core removes the stigma associated with possible proliferation concerns that are inherent in most fuel processing schemes. In particular, removal of all masses up to and including the lanthanides from the fuel salt can be achieved by applying the present subject matter. Method 670 does not remove the actinides from the side stream of MS fuels but injects them back to the reactor to be consumed as fuel. Method 670 can be performed on liter-sized batches of fuel salt per hour in a continuous mode using, for example, vortex or centrifugal separation in devices built with additive technologies.

In various embodiments, separation device 531 can be designed to address one or more of the following issues related to the separation by mass:
The fuel salt itself may change composition on its distillation. Even if this change is small, repeated distillation can shift the physical characteristics of the salt. To the extent that only the fission-products were removed, and everything else returned, this should not be a problem. The treated salt composition can be ascertained prior to its reintegration with the reactor fuel salt. Compositional deficiencies can be adjusted online.
Because of salt component interactions, important actinides such as AmF₃, PuF₃ may be induced into the vapor phase as mixed cation species (cations present in the fuel salt). The vapor phase composition of these complexes is unlikely to persist in the fuel salt to which they would be returned, but even so the volatility of actinides in whatever complexed form constitutes their mass separation.
As noted above, mass separation may additionally be foiled by oligomerization of salt components. A temperature assisted, mass separations approach then requires assessment of volatility data of the fuel salt and its components. High temperature data allowing for continuous removal of fission products from within the core containment region can be obtained. The obtained data can be used to choose a technology from available technologies determined by the separation of FP required from the fuel salt to maintain desired power production.
Actinides that remain with the fuel salt during distillation, or that certain actinides can be rerouted by their volatility to the final fuel salt, are key to burning actinides in general for the times required, for their removal from the fuel salt (ultimately converting them to fission products). The times required to do this can be determined for the applicable reactor type, methodology, loadings of NM(s), and salt type, among other things.

Computational methods can be used to understand the evolution of FPs, the evolution of important neutron poisons and their removal rate by fuel-salt processing, as well as the times required for deep burn of the actinides to occur. In various embodiment, the method of gas phase separation depends on several features of the vapor phase produced on heating the molten salt. High temperature data can inform chemical fluid dynamics (CFD) or other computational models as to the most effective design for the vapor phase separations.

Cyclonic, hydrocyclonic, vortex separators, and Tesla valves have been developed over several decades and today their industrial use has far outstripped their research. These devices generally have such advantages as simplicity of design, compactness; low production costs, high reliability; significant speed; implementation of several processes simultaneously: phase separation, cooling and heating of the gas flow. Positive qualities of the devices make it possible to make engineering systems manufacturable, speedy, easy to manufacture and operate, safe and even environmentally friendly.

The development of these kinds of devices for separations applicable to the nuclear industry appears to be a suitable area of research especially, in regard to the development of liquid/solid, liquid/gas, and even heat (hot gas-cold gas) separations. The overall improvements in the development of such devices, generally are derived from data-assisted computational fluid dynamics calculations. These devices may provide for economical, efficient methods of achieving several types of separations in MS reactors.

For example, a large set of solid/MS liquid species are a major source of concern to all MSR developers. The first bullet below concerns corrosion of the reactor materials of construction (MOC), the second bullet lists metal products that are nanoparticulate and act as a gas, can clog heat exchangers, are neutron poisons and confer a large radiolytic heat load to the reactor MOCs. The last bullet is related to the concern of critically by precipitation of the fertile material.
precipitated corrosion products: NiS, Cr metal, Ni metal, Fe metal.
Precipitated metal FP products Nb, Mo, Tc, Ru, Te, Rh,
Precipitated fissile UO₂-253, 233, PuO₂

The mass separations discussed herein should be a rather simple feat for such devices, while operational issues associated with a compact device that can vaporize the salt, inject the vapor (perhaps with a carrier gas such as helium) into a separation device, and then reject undesirable species require attention during its design. Another area where such devices can have transformational impact includes heat exchangers. In an MS reactor, these are large, costly devices that are corrosion prone. Data acquired from the extreme environments in which these devices operate allows for development of compact vortex-based heat exchangers with improved efficiencies.

In various embodiments, system 500 and method 670 provide an intrinsically proliferation resistant separation and do not at any point create a pure fissile separation. Fissile materials are not separated out to leave the core containment and are returned directly into the MS fuel. When U-238 is exhausted, breeding stops, and the remaining Pu-239 can be used with fresh fuel, or burned subcritically using accelerator produced neutrons to initiate fission chains.

In various embodiments, system 500 and method 670 can demonstrate an equivalent throughput processing rate of 1 kg/day for 8 h without any loss of selectivity. While new processes need to be demonstrated at this scale, using surrogates at larger scale and restricting chemistry with particularly hazardous materials to a smaller scale may be justified. The processing rate for removal of FP matches the requirements of the reactor to maintain its power output by keeping the MS fuel in dynamic equilibrium through a ‘polishing’ side-loop. This eliminates many expensive steps that conventional reprocessing techniques need. It is sized to prevent its parent reactor from, in principle, needing refueling during its lifetime—the output being ideally pure fission-product, and no long-lived actinides.

In various embodiments, system 500 and method 670 are either compatible with at least one existing licensed waste form or is codeveloped with a compatible waste form suitable for final geological disposal. The FP waste stream resulting from an application of the present subject matter is anticipated to have the radiotoxicity of natural uranium ore after 300 years, for which geological disposal of the FP waste is not necessary.

Examples of how the present subject matter can contribute to advancing nuclear energy deployment include:

### A. Energy Generation Economics

This project develops techniques to combine the demonstrated superconducting accelerator capabilities of the SNS Linac with the DOE MS reactor campaign based on the MSRE.

### B. Economic Competitiveness (Capital Cost, Operations Cost, Enhanced Performance).

It is anticipated that two features of Mu*STAR Nuclear Power Plants, subcritical operation and extremely low inventory of volatile radioisotopes in the core, can ease regulatory burdens to enable rapid development according to Edwards Deming's principles that can lead to the lowest capital and operational costs of NPPs.

### C. Capability to Penetrate Non-Electricity Market

High temperature process heat can convert renewable carbon (e.g., wood chips or industrial waste) and natural gas into green liquid fuel (e.g., diesel or jet fuel). While these are economically attractive energy products, we also see other potential revenues from a modified version focused on the production of tritium and helium-3. The high temperature of MS reactors (as much as 700 C) makes many other process-heat applications attractive, including hydrogen production.
   d. Enhanced Safety
Mu*STAR operates at atmospheric pressure with a subcritical core where fission can be stopped in a small fraction of a second by switching off the accelerator. The 500 MW thermal maximum power of the design corresponds to a core size that allows convective air cooling of decay heat. The accelerator, reactor, and volatile isotope storage/decay chambers are placed underground. The combination of subcritical operation and MS fuel offers significantly improved safety margins. The system is expected to be walk-away safe, containing none of the components that have been root causes of major reactor accidents.
   e. Reduced Regulatory Uncertainty
As a subcritical system driven by an accelerator, we anticipate a reduced regulatory burden compared to critical nuclear reactors. The list of significant accidents involving radioactive release is very much smaller (due to continuous removal of volatile fission products).
   f. Reduced Environmental Impact
Helium is used to sparge the main MS loop and continuously remove radioactive isotopes that are volatile at 700 C. The helium is piped to an underground facility that mines the gas cryogenically and chemically for valuable isotopes like tritium, leaving unwanted radioactive elements to be stored at sub-atmospheric pressure while they decay. The core maintains an inventory of volatile isotopes that can be almost 6 orders of magnitude less than in a typical LWR, reducing the possibility of significant unintentional releases from the core.

### G. Improved Management of Used Nuclear Fuel

Since the actinides in the SNF remain in the reactor, used fuel pools are not needed. By burning the used fuel from other reactors, Mu*STAR can significantly reduce the industry-wide burden of handling used fuel. The final waste stream is radiotoxic for only a few hundred years, making disposal much more manageable than an LWR's waste lifetime of ˜100,000 years.
   h. Reduced Proliferation Risk
The Mu*STAR accelerator can produce sufficient neutrons to beneficially use the remaining U-235 and Pu-239 in the SNF; the need for uranium enrichment is avoided.
   i. New Processes or Materials
Continuous extraction of isotopes from the core is a new process for harvesting useful materials.
   j. New Products or Markets
The production of tritium and its decay product helium-3 are attractive possibilities for Mu*STAR. Preliminary models using MCNP6.2 indicate that by using the natural lithium isotope ratio as the LiF component of the MS, one 500 MW thermal Mu*STAR unit could produce 2.4 kg of tritium per year, which exceeds the value of the electricity that is produced.

It is to be understood that the above detailed description is intended to be illustrative, and not restrictive. Other embodiments will be apparent to those of skill in the art upon reading and understanding the above description. The scope of the invention should, therefore, be determined with reference to the appended claims, along with the full scope of equivalents to which such claims are entitled.

What is claimed is:

1. A system for nuclear power generation, comprising:
an accelerator-driven subcritical nuclear reactor configured to operate using molten-salt fuel, the reactor including a target positioned to receive a proton beam and to be cooled by the molten-salt fuel;
an electrode positioned to be in contact with the molten-salt fuel in the reactor; and
a voltage source electrically coupled to the electrode, the voltage source configured to generate a voltage signal and to transmit the voltage signal to the electrode, the voltage signal suitable for controlling corrosion of the target and one or more other portions of the reactor that are in contact with the molten-salt fuel.

2. The system of claim 1, wherein the target is made of uranium.

3. The system of claim 2, wherein the target comprises the electrode.

4. The system of claim 2, wherein the electrode is separate from the target, and the electrode is made of uranium.

5. The system of claim 2, wherein the voltage source comprises:
a voltage generator configured to generate the voltage signal; and
a voltage controller configured to control the generation of the voltage signal for at least one of reducing chemical reaction between the uranium of the target and materials in the molten-salt fuel or reducing accumulation of materials on the target.

6. The system of claim 2, further comprising:
a beam pipe coupled to the reactor; and
a superconducting radio-frequency linear particle accelerator coupled to the beam pipe and configured to generate the proton beam to be injected into the reactor through the beam pipe to strike the target.

7. The system of claim 6, comprising multiple reactors including the accelerator-driven subcritical nuclear reactor and one or more additional accelerator-driven subcritical nuclear reactors each configured to operate using molten-salt fuel and including a target positioned to receive a proton beam and to be cooled by the molten-salt fuel, the multiple reactors each coupled to the superconducting radio-frequency linear particle accelerator to receive the proton beam from the accelerator-driven subcritical nuclear reactor.

8. The system of claim 7, wherein the multiple reactors are each a small modular reactor.

9. The system of claim 6, further comprising a fuel processing plant configured to receive spent nuclear fuel and to produce the molten-salt fuel using the spent nuclear fuel.

10. The system of claim 9, further comprising means for removing volatile radioactive fission products from the molten-salt fuel continuously during operation of the reactor to maintain an amount of the volatile radioactive fission products in the reactor below a threshold corresponding to a safety limit for accidental release of radioactive materials.

11. A method for nuclear power generation, comprising:
operating an accelerator-driven subcritical nuclear reactor using molten-salt fuel, including striking a target positioned with a proton beam and cooling the target using the molten-salt fuel;
generating a voltage signal; and
transmitting the voltage signal to an electrode in contact with the molten-salt fuel in the reactor,
wherein the voltage signal is suitable for controlling corrosion of the target and one or more other portions of the reactor that are in contact with the molten-salt fuel.

12. The method of claim 11, further comprising providing a uranium target to be the target.

13. The method of claim 12, wherein delivering the voltage signal to the electrode comprises delivering the voltage signal to a uranium electrode.

14. The method of claim 13, comprising using the target as the electrode, and delivering the voltage signal to the electrode comprises delivering the voltage signal to the target.

15. The method of claim 13, further comprising removing volatile radioactive fission products from the molten-salt fuel continuously during operation of the reactor, including:
producing a side stream of the molten-salt fuel flowing out of the reactor, the side stream including light fission products and actinides;
separating the light fission products from the actinides; and
returning the actinides to the reactor,
wherein the actinides include uranium.

16. The method of claim 13, further comprising:
passing helium flows over the molten-salt fuel in the reactor to remove volatile fission products from the molten-salt fuel; and
extracting one or more isotopes from the removed volatile fission products using fractional distillation.

17. The method of claim 13, further comprising controlling the generation of the voltage signal for at least one of reducing chemical reaction between the uranium of the target and materials in the molten-salt fuel or reducing accumulation of materials on the target.

18. The method of claim 11, further comprising:
generating the proton beam using a superconducting radio-frequency linear particle accelerator;
splitting the proton beam generated by the superconducting linear particle accelerator into multiple proton beams; and
operating multiple small modular reactors each being an instance of the accelerator-driven subcritical nuclear reactor, including injecting each proton beam of the multiple proton beams into a reactor of the multiple small modular reactors.

19. The method of claim 18, further comprising manufacturing the multiple small modular reactors in one or more factories remote from a site of the nuclear power generation.

20. The method of claim 11, further comprising producing the molten-salt fuel by processing spent nuclear fuel resulting from operation of one or more light water reactors.
